(19) United States
(12) Patent Application Publication
(10) Pub. No.: US 2020/0090035 A1
(43) Pub. Date: Mar. 19, 2020

(54) ENCODER-DECODER MEMORY-AUGMENTED NEURAL NETWORK ARCHITECTURES

(71) Applicant: INTERNATIONAL BUSINESS MACHINES CORPORATION, Armonk, NY (US)

(72) Inventors: Jayram Thathachar, Morgan Hill, CA (US); Tomasz Kornuta, San Jose, CA (US); Ahmet Serkan Ozcan, Los Altos, CA (US)

(21) Appl. No.: 16/135,990

(22) Filed: Sep. 19, 2018

(51) Int. Cl. G06N 3/08; G06N 3/04; G06N 3/063

(52) U.S. Cl. CPC G06N 3/08; G06N 3/063; G06N 3/0454

(57) ABSTRACT

Memory-augmented neural networks are provided. In various embodiments, an encoder artificial neural network is adapted to receive an input and provide an encoded output based on the input. A plurality of decoder artificial neural networks is provided, each adapted to receive an encoded input and provide an output based on the encoded input. A memory is operatively coupled to the encoder artificial neural network and to the plurality of decoder artificial neural networks. The memory is adapted to store the encoded output of the encoder artificial neural network and provide the encoded input to the plurality of decoder artificial neural networks.

### BACKGROUND

Embodiments of the present disclosure relate to memory-augmented neural networks, and more specifically, to encoder-decoder memory-augmented neural network architectures.

### BRIEF SUMMARY

According to embodiments of the present disclosure, neural network systems are provided. An encoder artificial neural network is adapted to receive an input and provide an encoded output based on the input. A plurality of decoder artificial neural networks is provided, each adapted to receive an encoded input and provide an output based on the encoded input. A memory is operatively coupled to the encoder artificial neural network and to the plurality of decoder artificial neural networks. The memory is adapted to store the encoded output of the encoder artificial neural network and provide the encoded input to the plurality of decoder artificial neural networks.

According to embodiments of the present disclosure, methods of and computer program products for operating neural networks are provided. Each of a plurality of decoder artificial neural networks are jointly trained in combination with an encoder artificial neural network. The encoder artificial neural network is adapted to receive an input and provide an encoded output based on the input to a memory. Each of the plurality of decoder artificial neural networks is adapted to receive an encoded input from a memory and provide an output based on the encoded input.

According to embodiments of the present disclosure, methods of and computer program products for operating neural networks are provided. A subset of a plurality of decoder artificial neural networks is jointly trained in combination with an encoder artificial neural network. The encoder artificial neural network is adapted to receive an input and provide an encoded output based on the input to a memory. Each of the plurality of decoder artificial neural networks is adapted to receive an encoded input from a memory and provide an output based on the encoded input. The encoder artificial neural network is frozen. Each of the plurality of decoder artificial neural networks is separately in combination with the frozen encoder artificial neural network.

### BRIEF DESCRIPTION OF THE SEVERAL VIEWS OF THE DRAWINGS

FIGS. 1A-E illustrate a suite of working memory tasks according to embodiments of the present disclosure.

FIGS. 2A-C illustrate the architecture of a neural Turing machine cell according to embodiments of the present disclosure.

FIG. 3 illustrates the application of a neural Turing machine to a store-recall task according to embodiments of the present disclosure.

FIG. 4 illustrates the application of an encoder-decoder neural Turing machine to a store-recall task according to embodiments of the present disclosure.

FIG. 5 illustrates an encoder-decoder neural Turing machine architecture according to embodiments of the present disclosure.

FIG. 6 illustrates an exemplary encoder-decoder neural Turing machine model trained on a serial recall task in an end-to-end manner according to embodiments of the present disclosure.

FIG. 7 illustrates training performance of an exemplary encoder-decoder neural Turing machine trained on a serial recall task in end-to-end manner according to embodiments of the present disclosure.

FIG. 8 illustrates an exemplary encoder-decoder neural Turing machine model trained on a reverse recall task according to embodiments of the present disclosure.

FIG. 9 illustrates an exemplary encoder's write attention during processing and final memory map according to embodiments of the present disclosure.

FIGS. 10A-B illustrate exemplary memory contents according to embodiments of the present disclosure.

FIG. 11 illustrates an exemplary encoder-decoder neural Turing machine model trained on a reverse recall task in an end-to-end manner according to embodiments of the present disclosure.

FIG. 12 illustrates training performance of an exemplary encoder-decoder neural Turing machine model trained jointly on serial recall and reverse recall tasks according to embodiments of the present disclosure.

FIG. 13 illustrates an exemplary encoder-decoder neural Turing machine model used for joint training of serial and reverse recall tasks according to embodiments of the present disclosure.

FIG. 14 illustrates performance of a Sequence Comparison Task according to embodiments of the present disclosure.

FIG. 15 illustrates performance of an equality task according to embodiments of the present disclosure.

FIG. 16 illustrates an architecture of a single-task memory-augmented encoder-decoder according to embodiments of the present disclosure.

FIG. 17 illustrates an architecture of a multi-task memory-augmented encoder-decoder according to embodiments of the present disclosure.

FIG. 18 illustrates a method of operating a neural networks according to an embodiment of the present disclosure.

FIG. 19 depicts a computing node according to an embodiment of the present disclosure.

### DETAILED DESCRIPTION

Artificial neural networks (ANNs) are distributed computing systems, which consist of a number of neurons interconnected through connection points called synapses. Each synapse encodes the strength of the connection between the output of one neuron and the input of another. The output of each neuron is determined by the aggregate input received from other neurons that are connected to it. Thus, the output of a given neuron is based on the outputs of connected neurons from preceding layers and the strength of the connections as determined by the synaptic weights. An ANN is trained to solve a specific problem (e.g., pattern recognition) by adjusting the weights of the synapses such that a particular class of inputs produce a desired output.

Various improvements may be included in a neural network, such as gating mechanisms and attention. In addition, a neural network may be augmented with external memory modules to extend their capabilities in solving diverse tasks, e.g., learning context-free grammars, remembering long sequences (long-term dependencies), learning to rapidly assimilate new data (e.g., one-shot learning) and visual question answering. In addition, external memory may also be used in algorithmic tasks such as copying sequences, sorting digits and traversing graphs.

Memory Augmented Neural Networks (MANNs) provide opportunities to analyze the capabilities, generalization performance, and the limitations of those models. While certain configurations ANNs may be inspired by human memory, and make links to working or episodic memory, they are not limited to such tasks.

The present disclosure provides a MANN architecture using a Neural Turing Machine (NTM). This memory-augmented neural network architecture enables transfer learning and solves complex working memory tasks. In various embodiments, Neural Turing Machines are combined with an Encoder-Decoder approach. This model is general purpose and capable of solving multiple problems.

In various embodiments, the MANN architecture is referred to as an Encoder-Decoder NTM (ED-NTM). As set out below, different types of encoders are studied in systematic manner, showing an advantage of multi-task learning in obtaining the best possible encoder. This encoder enables transfer learning to solve a suite of working memory tasks. In various embodiments, transfer learning for MANNs is provided (as opposed to tasks learned in separation). The trained models can also be applied to related ED-NTMs that are capable of handling much larger sequential inputs with appropriately large memory modules.

Embodiments of the present disclosure address the requirements of a working memory, in particular with regard to tasks that are employed by cognitive psychologists, and are designed to avoid the mixture of working and long-term memory. Working memory relies on multiple components that can adapt to solving novel problems. However, there are core competencies that are universal and shared between many tasks.

Humans rely on working memory for many domains of cognition, including planning, solving problems, language comprehension and production. The common skill in these tasks is holding information in mind for a short period of time as the information is processed or transformed. Retention time and capacity are two properties that distinguish working memory from long-term memory. Information stays in working memory for less than a minute, unless it is actively rehearsed, and the capacity is limited to 3-5 items (or chunks of information) depending on the task complexity.

Various working memory tasks shed light on the properties and underlying mechanisms of working memory. Working memory is a multi-component system responsible for active maintenance of information despite ongoing manipulation or distraction. Tasks developed by psychologists aim to measure a specific facet of working memory such as capacity, retention, and attention control under different conditions that may involve processing and/or a distraction.

One working memory task class is span tasks, which are usually divided into simple span and complex span. The span refers to some sort of sequence length, which could be digits, letters, words, or visual patterns. The simple span tasks only require the storage and maintenance of the input sequence, and measure the capacity of the working memory. Complex span tasks are interleaved tasks that requires manipulation of information and forces the maintenance during a distraction (typically a second task).

From the point of view of solving such tasks, four core requirements for working memory may be defined: 1) Encoding the input information into a useful representation; 2) Retention of information during processing; 3) Controlled attention (during encoding, processing and decoding); and 4) Decoding the output to solve the task. Those core requirements are consistent regardless of the task complexity.

The first requirement emphasizes the usefulness of the encoded representation in solving tasks. For a serial recall task, the working memory system needs to encode the input, retain the information, and decode the output to reproduce the input after a delay. This delay means that the input is reproduced from the encoded memory content and not just echoed. Since there are multiple ways to encode information, the efficiency and usefulness of the encoding may vary for a variety of tasks.

A challenge in providing retention (or active maintenance of information) in computer implementations is to prevent interference and corruption of the memory content. In relation to this, controlled attention is a fundamental skill, which is roughly the analog of addressing in computer memory. Attention is needed for both encoding and decoding since it dictates where the information is written to and read from. In addition, the order of items in the memory is usually important for many working memory tasks. However, it does not imply that temporal order of events will be stored, as it is the case for episodic memory (a type of long-term memory). Similarly, unlike the long-term semantic memory, there is not strong evidence for content-based access in working memory. Therefore, in various embodiments, location-based addressing is provided by default, with content-based addressing provided on a task-by-task basis.

In more complex tasks, the information in the memory needs to be manipulated or transformed. For example, when solving problems such as arithmetic problems, the input is temporarily stored, the contents are manipulated, and an answer is produced as the goal is kept in mind. In some other cases, interleaved tasks may be performed (e.g., a main task and a distraction task), which may cause memory interference. Controlling attention is important in these cases so that the information related to the main task is kept under the focus and not overwritten by the distraction.

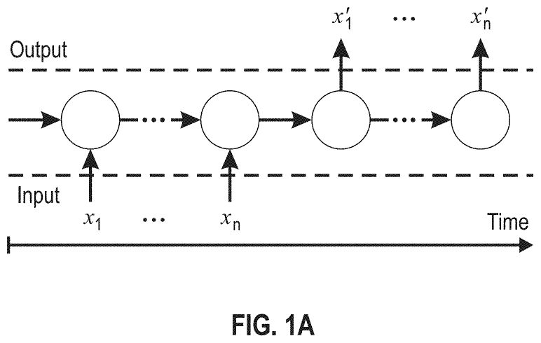

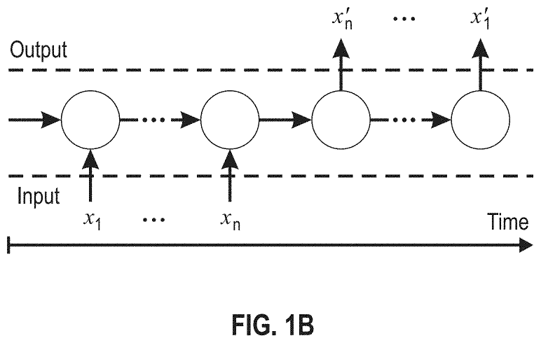

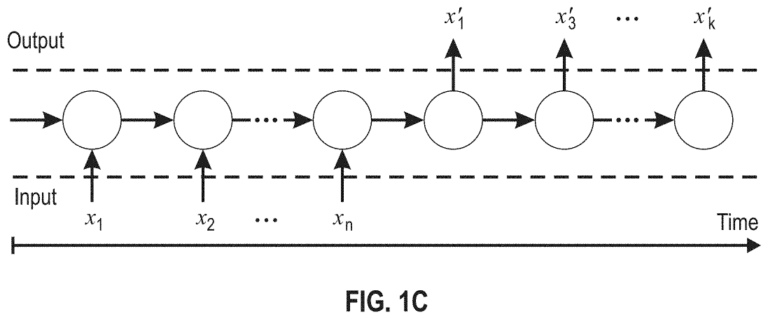

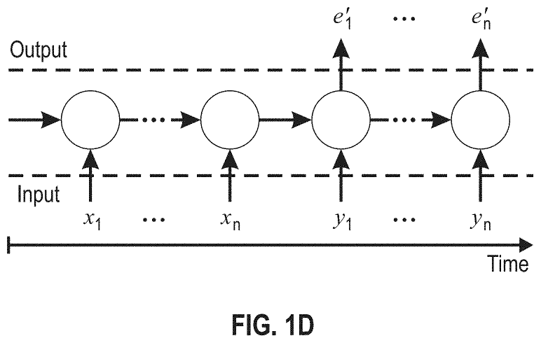

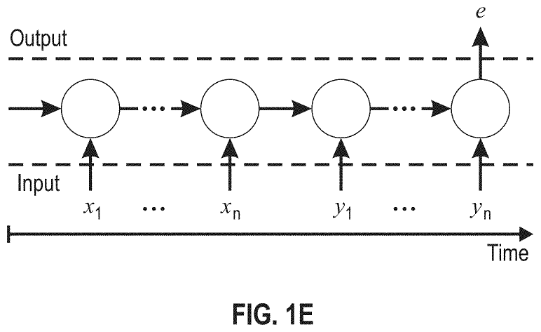

Referring to FIG. 1, a suite of exemplary working memory tasks is illustrated.

FIG. 1A illustrates Serial Recall, which is based on the ability to recall and reproduce a list of items in the same order as the input after a brief delay. This may be considered a short-term memory task, as there is no manipulation of information. However, in the present disclosure, tasks are referred to as pertaining to working memory, without differentiating short-term memory based on the task complexity.

FIG. 1B illustrates Reverse Recall, which requires reproducing the input sequence in reverse order.

FIG. 1C illustrates Odd Recall, which aims to reproduce every other element of the input sequence. This is a step towards complex tasks that require working memory to recall certain input items while ignoring others. For example, in a read span task, subjects read sentences and are supposed to reproduce the last word of every sentence in order.

FIG. 1D illustrates Sequence Comparison, in which one needs to encode the first sequence, retain it in memory, and later produce outputs (e.g., equal/not equal) as the elements of a second sequence are received. Unlike the prior tasks, this task requires data manipulation.

FIG. 1E illustrates Sequence Equality. This task is more difficult because it requires remembering the first sequence, comparing the items element-wise and keeping the intermediate results (whether consecutive items are individually equal or not) in the memory, and finally producing a single output (are these two sequences equal or not). As the supervisory signal provides only one bit of information at the end of two sequences with varying length, there is an extreme disproportion between the information content of input and output data, making the task challenging.

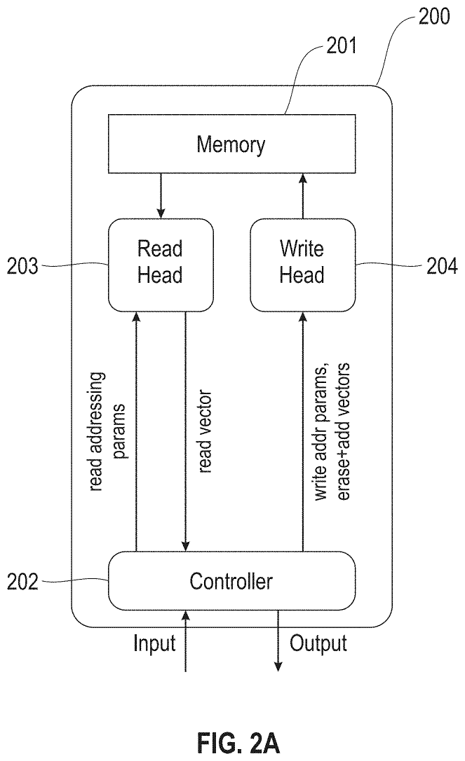

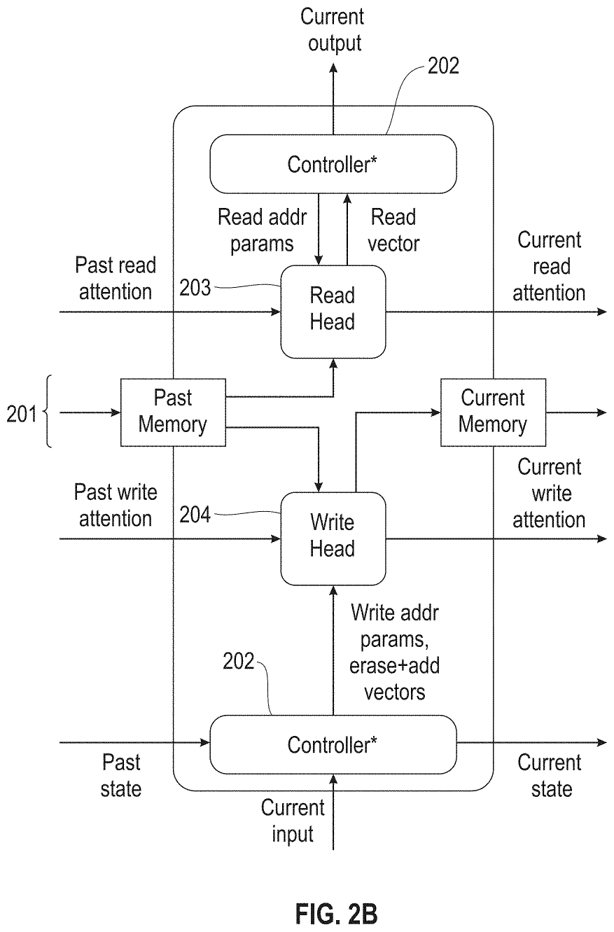

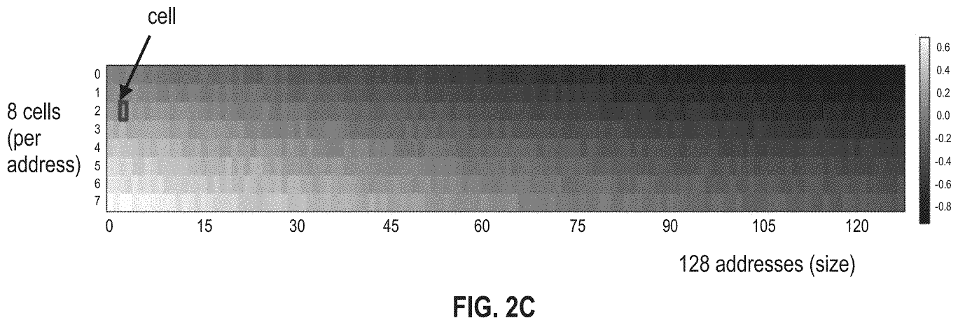

Referring to FIG. 2, the architecture of a Neural Turing Machine cell is illustrated.

Referring to FIG. 2A, Neural Turing Machine 200 includes memory 201 and controller 202. Controller 202 is responsible for interacting with the external world via inputs and outputs, as well as accessing memory 201 through its read head 203 and write head 204 (by analogy to Turing machine). Both heads 203 . . . 204 perform two processing steps, namely addressing (combining content-based and location-based addressing) and operation (read for read head 203 or erase and add for write head 204). In various embodiments, the addressing is parametrized by values produced by the controller, thus the controller effectively decides to focus its attention on the relevant elements of the memory. As the controller is implemented as a neural network and every component is differentiable, the whole model can be trained using continuous methods. In some embodiments, the controller is divided into two interacting components: a controller module and a memory interface module.

Referring to FIG. 2B, the temporal data flow when applying NTM to sequential tasks is shown. Since controller 202 can be considered as a gate, which controls input and output information, the two graphically distinguished components are in fact the same entity in the model. Such a graphical representation illustrates application of the model to sequential tasks.

In various embodiments, the controller has an internal state that gets transformed in each step, similar to a cell of a recurrent neural network (RNN). As set out above, it has the ability to read from and write to Memory in each time step. In various embodiments, memory is arranged as a 2D array of cells. The columns may be indexed starting from 0, and the index of each column is called its address. The number of addresses (columns) is called the memory size. Each address contains a vector of values with fixed dimension (vector valued memory cells) called the memory width. An exemplary memory is illustrated in FIG. 2C.

In various embodiments, content-addressable memory and soft addressing are provided. In both cases, a weighting function over the addresses is provided. These weighting functions can be stored in the memory itself on dedicated rows, providing generality to the models described herein.

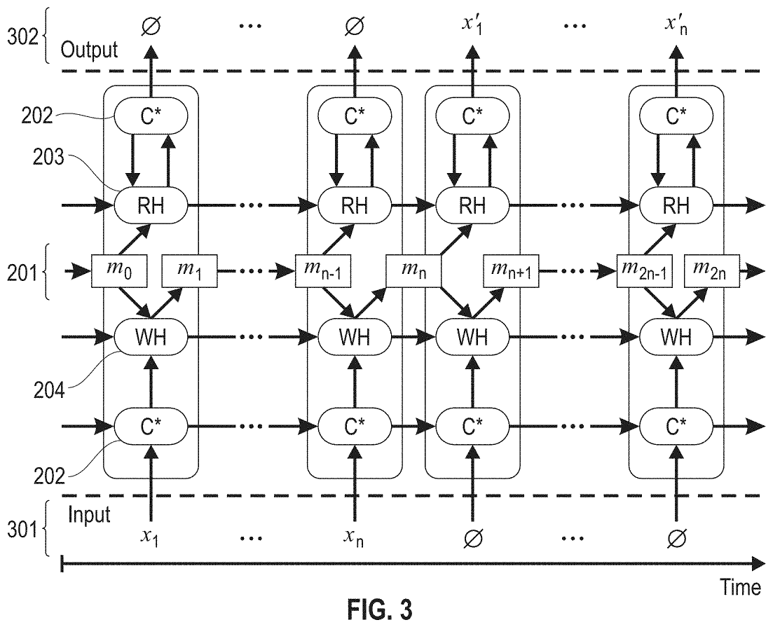

Referring to FIG. 3, the application of a Neural Turing Machine to a serial recall task is illustrated. In this figure, controller 202, write head 204, and read head 203 are as described above. A sequence of inputs 301 {x₁ . . . xₙ} are provided, which lead to sequence of outputs 302 {x′₁ . . . x′ₙ}. Ø represents skipped output or empty (e.g., vector of zeros) input.

Based on the above, the main role of the NTM cell during input is encoding inputs and retaining them in the memory. During recall, its function is to manipulate the input, combine with the memory, and decode the resulting representation to the original representation. Accordingly, the roles of two distinctive components may be formalized. In particular, a model is provided consisting of two separate NTMs, playing the role of Encoder and Decoder.

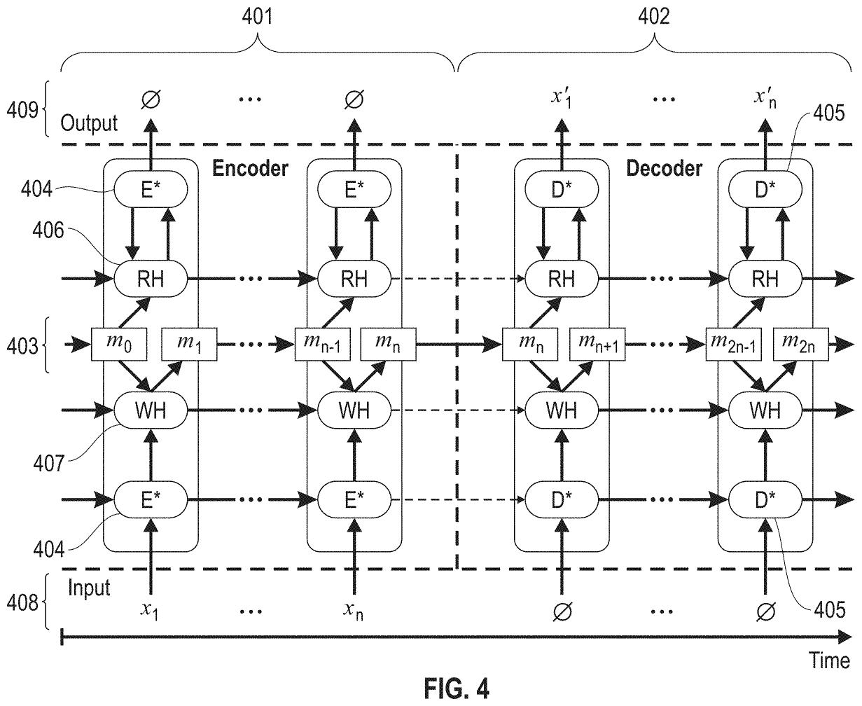

Referring to FIG. 4, an Encoder-Decoder Neural Turing Machine is illustrated, as applied to the store-recall task of FIG. 3. In this example, an encoder stage 401 and decoder stage 402 are provided. A memory 403 is addressed by encoder stage controller 404 and decoder stage controller 405. Through read heads 406 and write heads 407. Encoder stage 401 receives a sequence of inputs 408, and decoder stage 402 generates a sequence of outputs 409. Memory retention (passing the memory content from Encoder to Decoder) is provided in this architecture, in contrast to passing the read/write attention vectors or hidden state of the controller. This is indicated in FIG. 4 by using solid line for the former and dotted lines for the latter.

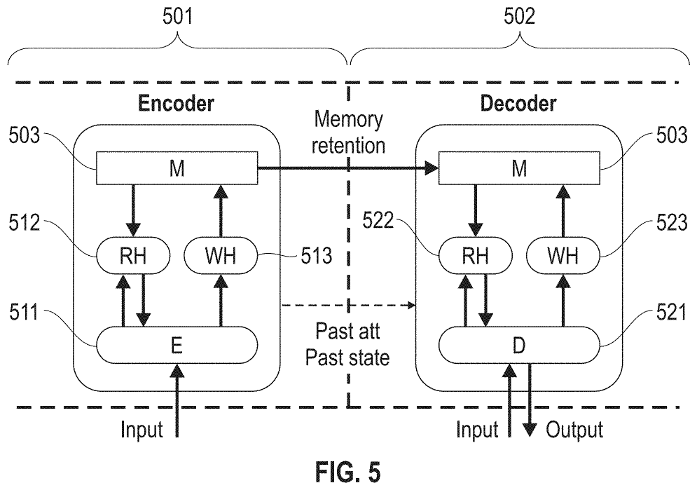

Referring to FIG. 5, a general Encoder-Decoder Neural Turing Machine architecture is illustrated. Encoder 501 includes controller 511, which interacts with memory 503 via read head 512 and write head 513. Decoder 502 includes controller 521, which interacts with memory via read head 522 and write head 523. Memory retention is provided between encoder 501 and decoder 502. Past attention and past state are transferred from encoder 501 to decoder 502. This architecture is general enough to be applied to diverse tasks, including the working memory tasks described herein. As decoder 502 is responsible for learning how to realize a given task, encoder 501 is responsible for learning the encoding that will help decoder 502 fulfill its task.

In some embodiments, a universal encoder is trained that will foster mastering diverse tasks by specialized decoders. This allows the use of transfer learning—the transfer of knowledge from a related task that has already been learned.

In an exemplary implementation of ED-NTMs, Keras with Tensorflow was used as the backend. Experiments were conducted on a machine configured with a 4-core Intel CPU chip @3.40 GHz along with a single Nvidia GM200 (GeForce GTX TITAN X GPU) coprocessor. Throughout the experiments, the input item size was fixed to be 8 bits, so that the sequences consist of 8-bit words of arbitrary length. To provide a fair comparison of the training, validation, and testing for the various tasks, the following parameters were fixed for all the ED-NTMs. The real vectors stored at each memory address were 10-dimensional, and sufficient to hold one input word. The encoders were one-layer feed-forward neural networks with 5 output units. Given the small size, the encoder's role is only to handle the logic of the computation whereas the memory is the only place where the input is encoded. The decoders' configuration varied from one task to another but the largest was a 2-layer feedforward network with a hidden layer of 10 units. This enabled tasks such as sequence comparison and equality, where element-wise comparison was performed on 8-bit inputs (this is closely related to the XOR problem). For the other tasks, a one-layer network was sufficient.

The largest network trained contained less than 2000 trainable parameters. In ED-NTMs (and other MANNs in general), the number of trainable parameters does not depend on the size of the memory. However, the size of the memory should be fixed in order to ensure that the various parts of an ED-NTM, such as the memory or the soft attention of read and write heads, have a bounded description. Thus, an ED-NTM may be thought of as representing a class of RNNs where each RNN is parameterized by the size of the memory, and each RNN can take arbitrarily long sequences as its input.

During training, one such memory size was fixed and training was conducted with sequences that are short enough for that memory size. This yields a particular fixing of the trainable parameters. However, as the ED-NTM can be instantiated for any choice of memory size, for longer sequences an RNN may be picked from a different class corresponding to a larger memory size. The ability of the ED-NTMs to generalize in this manner when training using smaller memory also allows generalization to happen for longer sequences with large enough memory sizes is referred to as memory-size generalization.

In the exemplary training experiments, the memory size was limited to 30 addresses, and sequences of random lengths were chosen between 3 and 20. The sequence itself also consisted of randomly chosen 8-bit words. This ensured that the input data did not contain any fixed patterns so that the trained model doesn't memorize the patterns and can truly learn the task across all data. The (average) binary cross-entropy was used as the natural loss function to minimize during training since all of the tasks, including the tasks with multiple outputs, involved the atomic operation of comparing the predicted output to the target in a bit-by-bit fashion. For all the tasks, except sequence comparison and equality, the batch size did not affect the training performance significantly so the batch size was fixed to be 1 for all these tasks. For equality and sequence comparison a batch size of 64 was chosen.

During training, validation was periodically performed on a batch of 64 random sequences, each of length 64. The memory size was increased to 80 so that the encoding could still fit into memory. This is a mild form of memory-size generalization. For all the tasks, as soon as the loss function dropped to 0.01 or less, the validation accuracy was at 100%. However, this did not necessarily result in perfect accuracy while measuring memory-size generalization for much larger sequence lengths. To ensure that this would happen, the training was continued until the loss function value was 10⁻⁵ or less for all the tasks. The key metric was the number of iterations required to reach this loss value. At that point, the training was considered to have (strongly) converged. The data generators could produce an infinite number of samples, so training could continue forever. In cases where the threshold was reached, the convergence would happen within 20,000 iterations, hence, the training was stopped only if it did not converge in 100,000 iterations.

To measure true memory-size generalization, the network was tested on sequences of length 1000, which required a larger memory module of size 1024. Since the resulting RNNs were large in size, testing was performed on smaller batch sizes of 32 and then averaged over 100 such batches containing random sequences.

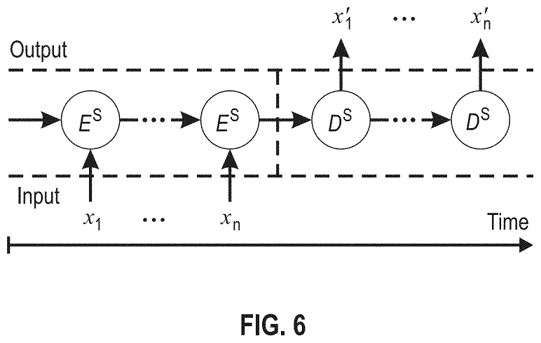

Referring to FIG. 6, an exemplary ED-NTM model trained on a serial recall task in an end-to-end manner is illustrated. In this exemplary experiment, the ED-NTM model was composed as presented in FIG. 6, and trained it on the serial recall task in an end-to-end manner.

In this setting, the goal of the encoder E^{S} (from Encoder-Serial) was to encode and store the inputs in memory, whereas the goal of the decoder D^{S} (from Decoder-Serial) was to reproduce the output.

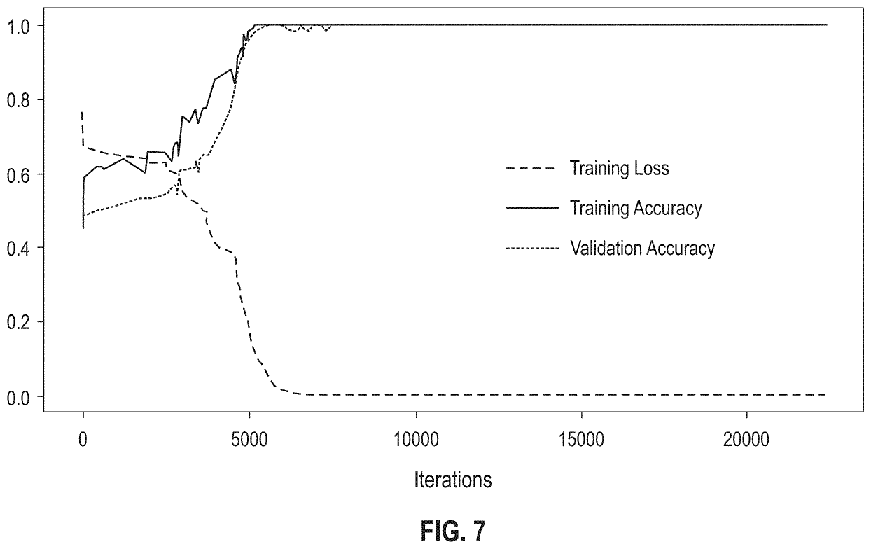

FIG. 7 shows the training performance with this encoder design. This procedure took about 11,000 iterations for the training to converge (loss of 10⁻⁵) while achieving perfect accuracy for memory-size generalization on sequences of length 1000.

In the next step the trained encoder E^{S} was reused for other tasks. For that purpose, transfer learning was used. The pre-trained E^{s} with frozen weights was connected with new, freshly initialized decoders.

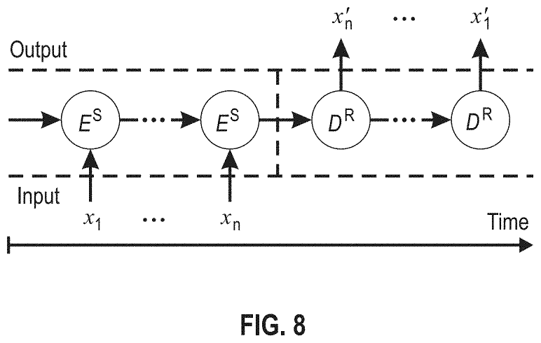

FIG. 8 illustrates an exemplary ED-NTM model used for a reverse recall task. In this example, the encoder portion of the model is frozen. The encoder E^{S} was pretrained on the serial recall task (D^{R} stands for Decoder-Reverse).

The results for ED-NTM using encoder E^{S} pre-trained on the serial recall task are presented in Table 1. The training time is reduced by nearly half, even for the serial recall which was used to pre-train the encoder. Moreover, this was sufficient to handle the forward processing sequential tasks such as odd and equality. For sequence comparison, the training did not converge and the loss function value could only get as small as 0.02 but, nevertheless, memory-size generalization was about 99.4%. For the reverse recall task, the training failed completely and the validation accuracy did no better than random guessing.

TABLE 1

| Task | Time to Convergence | Memory-Size Generalization |
|---|---|---|
| Serial Recall | 6,000 | 100% |
| Reverse Recall | Fail | Fail |
| Odd | 6,900 | 100% |
| Equality | 27,000 | 100% |
| Comparison | Fail | 99.4% |

To address the training failure for reverse recall, two experiments were performed to study the behavior of the E^{S} encoder. The goal of the first experiment was to validate whether each input is encoded and stored under exactly one memory address.

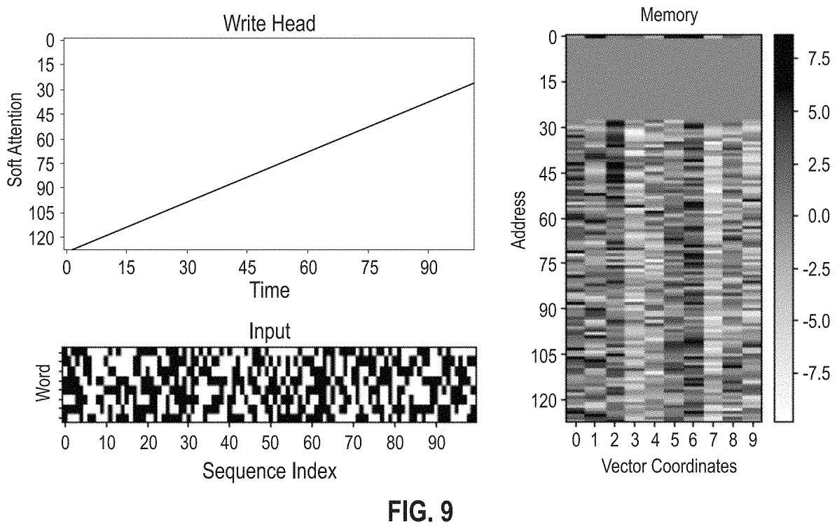

FIG. 9 shows the write attention as a randomly chosen input sequence of length 100 is being processed. The memory has 128 addresses. As shown, the trained model essentially uses only hard attention to write to memory. Furthermore, each write operation is applied to a different location in the memory and these occur sequentially. This was observed for all the encoders tried under different choice of the random seed initialization. In some cases, the encoder used the lower portion of the memory while in this case the upper portion of the memory addresses was used. This results from the fact that in some cases (separate training episodes) the encoder has learned to shift the head one address forward, and in the other backward. Thus, the encoding of the k-th element is k-1 locations away from the location where the first element is encoded (viewing memory addresses in a circular fashion).

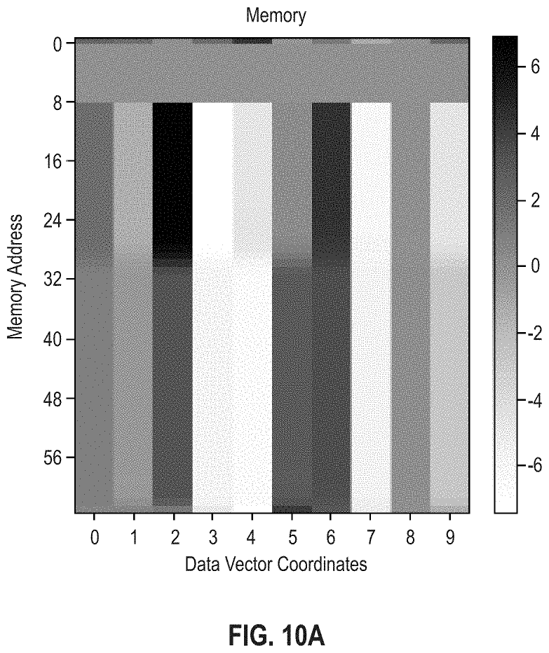

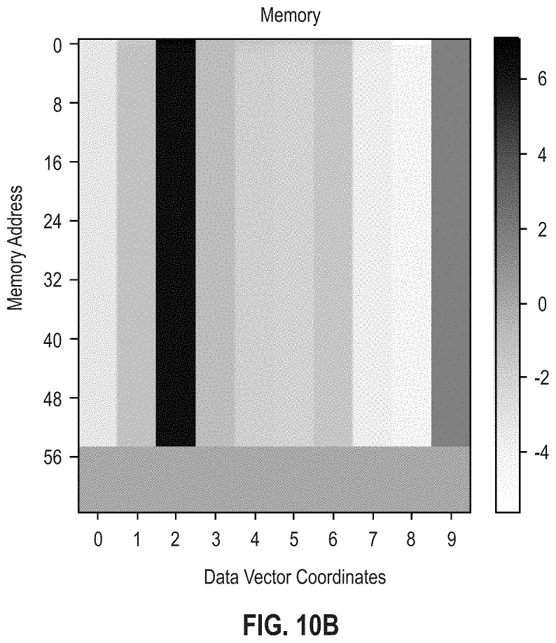

In the second experiment the encoder was fed a sequence consisting of the same element being repeated throughout. FIG. 10 illustrates the memory contents after storing a sequence consisting of the same element with different elements (the right content is the desired one). In such a task it is preferable that the content of every memory address where the encoder decided to write should be exactly the same, as shown in FIG. 10B for an encoder described below. As shown in in FIG. 10A, when the encoder E^{S} is operational, not all locations are encoded in the same manner and there are slight variations between the memory locations. This indicated that the encoding of each element is also influenced by the previous elements of the sequence. In other words, the encoding has some sort of forward bias. This is the apparent reason why the reverse recall task fails.

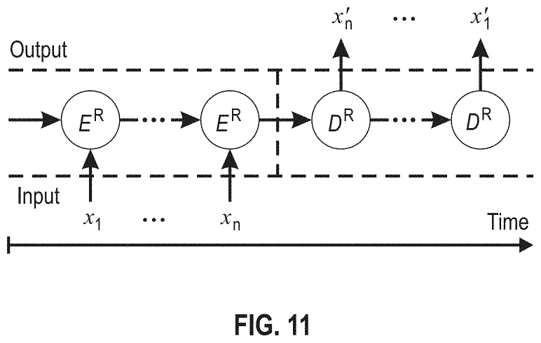

To eliminate the forward bias so that each element is encoded independent of the others, a new encoder-decoder model is provided that is trained on a reverse recall task from scratch in an end-to-end manner. This exemplary ED-NTM model is illustrated in FIG. 11. The role of encoder E^{R} (from Encoder-Reverse) is to encode and store inputs in the memory, and decoder D^{R} is trained to produce the reverse of the sequence. Because unbounded jumps in attention are not allowed in this design of the ED-NTM, an additional step is added in which the read attention of the decoder is initialized to be the write attention of the encoder at the end of processing the input. This way the decoder can possibly recover the input sequence in reverse by learning to shift the attention in the reverse order.

The encoder trained by this process should be free of forward bias. Consider a perfect encoder-decoder for producing the reverse of the input for sequences of all lengths. Let the input sequence be x₁, x₂, . . . , xₙ for some arbitrary n where n is not known to the encoder in advance. Assume that similar to the earlier case of encoder E^{S}, this sequence has been encoded as z₁, z₂, . . . , zₙ where for each k, zₖ=fₖ(x₁, x₂, . . . , xₖ) for some function fₖ. To have no forward bias, it must be shown that z depends only on x, i.e. z=f(x). Then for the hypothetical sequence x₁, x₂, . . . , xₖ, the encoding of xₖ will still equal zₖ since the length of the sequence is not known in advance. For this hypothetical sequence, the decoder starts by reading zₖ. Since it has to output xₖ, the only way for this to happen is when there is one-to-one mapping between the set of xₖ's and the set of zₖ's. Thus, fₖ depends only on xₖ and there is no forward bias. Since k was chosen arbitrarily, this claim holds for all k, showing that the resulting encoder should have no forward bias.

The above approach hinges on the assumption of perfect learning. In these experiments, validation accuracy of 100% was achieved for decoding the forward as well as reverse order of the input sequence (serial and reverse recall tasks). However, the training did not converge and the best loss function value was about 0.01. With such a large training loss, the memory-size generalization worked well for sequences up to length 500, achieving perfect 100% accuracy (with a large enough memory size). However, beyond that length, the performance started to degrade, and at length 1000, the test accuracy was only as high as 92%.

To obtain an improved encoder capable of handling both forward and reverse-oriented sequential tasks, a Multi-Task Learning (MTL) approach using hard parameter sharing is applied. Thus, a model is built having a single encoder and many decoders. In various embodiments, it is not jointly train on all the tasks.

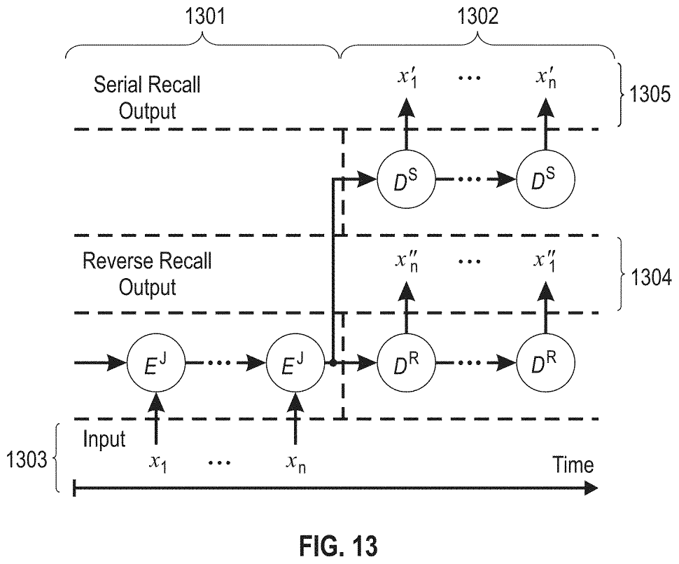

FIG. 13 illustrates an ED-NTM model used for joint training of serial and reverse recall tasks. In this architecture, a joint encoder 1301 precedes separate serial recall and reverse recall decoders 1302. In the model presented in FIG. 13, the encoder (E^{J} from Encoder-Joint) is explicitly enforced to produce an encoding that is simultaneously good for both the serial (D^{S}) and reverse recall tasks (D^{R}). This form of inductive bias is applied to build good decoders independently for other sequential tasks.

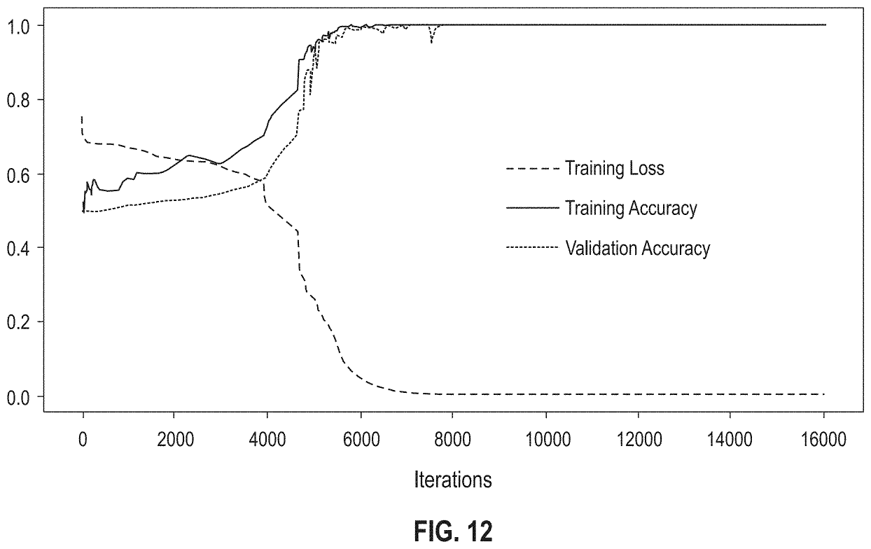

FIG. 12 illustrates training performance of an ED-NTM model trained jointly on serial recall and reverse recall tasks. Training loss of 10⁻⁵ is obtained after ˜12,000 iterations. Compared to the training of the first encoder E^{S}, the training loss takes a longer time to start dropping, but still the overall convergence was only about 1000 iterations longer compared to the encoder E^{S}. However, as presented in FIG. 10B, the encoding of the repeated sequence stored in memory is near-uniform across all the locations, demonstrating the elimination of forward bias.

This encoder is applied to further working memory tasks. In all of these tasks the encoder E^{J} was frozen and only task-specific decoders were trained. The aggregated results can be found in Table 2.

TABLE 2

| Task | Time to Convergence | Memory-Size Generalization |
|---|---|---|
| Serial Recall | 7,000 | 100% |
| Reverse Recall | 6,900 | 100% |
| Odd | 7,200 | 100% |
| Equality | 9,200 | 100% |
| Comparison | 11,000 | 100% |

Since the encoder E^{J} was designed with the purposes of being able to do both tasks well (depending on where the attention is given to the solver), an improved result is obtained over training them end-to-end individually. The training for reverse recall is quite fast and for serial recall it is faster than the encoder E^{S}.

In an exemplary implementation of the odd task described above, the E^{J} encoder was provided with a decoder that has only basic attention shift mechanism (that is able to shift at most 1 memory address in each step). it was verified that this does not train well, as the attention on the encoding needs to jump by 2 locations in each step. The training did not converge at all with a loss value close to 0.5. After adding the additional capability for the decoder to be capable of shifting its attention by 2 steps, the model converged in about 7,200 iterations.

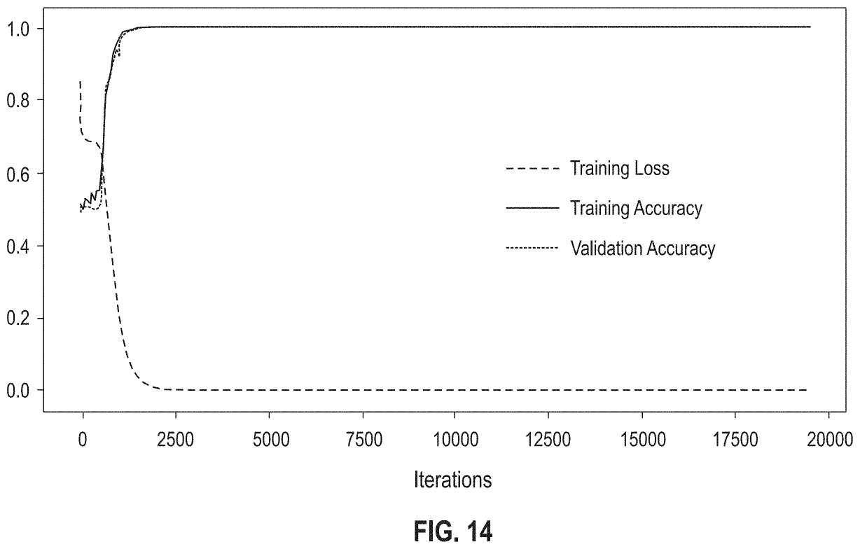

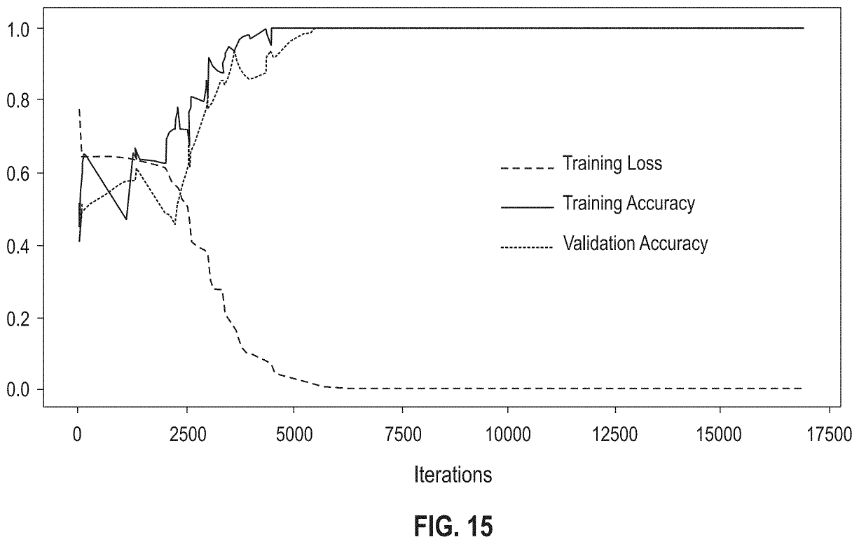

Exemplary embodiments of sequence comparison and equality tasks both involve comparing the decoder's input element-wise to that of the encoder. So, to compare their training performance, the same parameters for both the tasks were used. In particular, this resulted in the largest number of trainable parameters due to the additional hidden layer (with ReLU activation). Since equality is a binary classification problem, having small batch sizes caused enormous fluctuations in the loss function during training. Choosing a larger batch size of 64 stabilized this behavior and allowed the training to converge in about 11,000 iterations for sequence comparison (as shown in FIG. 14) and about 9,200 iterations for equality (as shown in FIG. 15). While the wall time was not affected by this larger batch size (due to efficient GPU utilization), it is important to note that the number of data samples is indeed much larger than that for the other tasks.

Equality exhibits larger fluctuations in the initial phase of training due to the loss being averaged only over 64 values in the batch. It also converged faster, because the information available to the trainer is just a single bit for the equality task. This happened because the distribution of instances to the equality problem is such that even with a small number of mistakes on the individual comparisons there exists an error-free decision boundary for separating the binary classes.

It will be appreciated that the present disclosure is applicable to additional classes of working memory tasks, such as memory distraction tasks. The characteristic of such dual-tasks is the ability to shift attention in the middle of solving the main task to tackle a different task temporarily and then return to the main task. Solving such tasks in the ED-NTM framework described herein requires suspending the encoding of the main input in the middle, shifting attention to possibly another portion of the memory to handle the input that represents the distraction task, and finally returning attention to where the encoder was suspended. Since the distraction can appear anywhere in the main task, this requires a dynamic encoding technique.

In addition, the present disclosure is applicable to visual working memory tasks. These require adopting suitable encodings for images.

In general, the operation of a MANN as described above may be described in terms of how data flows through it. The input is sequentially accessed, and the output is sequentially produced in tandem with the input. Let x=x₁, x₂, . . . , xₙ, denote the input sequence of elements and y=y₁, y₂, . . . , yₙ denote the output sequence of elements. It may be assumed without loss of generality that each element belongs to a common domain D. D may be ensured to be large enough to handle special situations, e.g., special symbols to segment the input, create dummy inputs, etc.

For all time steps t=1,2,3, . . . , T: xₜ is the input element accessed during time step t; yₜ is the output element produced during time step t; qₜ denotes the (hidden) state of the controller at the end of time t with q₀ as the initial value; mₜ denotes the contents of memory at the end of time t with m₀ as the initial value; rₜ denotes the read data, a vector of values, to be read from memory during time step t; uₜ denotes the update data, a vector of values, to be written to memory during time step t.

The dimensions of both rₜ and uₜ can depend on the memory width. However, these dimensions may be independent of the size of memory. With further conditions on the transformation functions described below, the consequence is that for a fixed controller (meaning the parameters of the neural network are frozen), a memory module may be sized based on the length of the input sequence to be processed. While training such MANNs, short sequences can be used, and after training converges, the same resulting controller can be used for longer sequences.

The equations governing the time evolution of the dynamical system underlying the MANN are as follows.

rₜ=MEM_READ(mₜ₋₁)

(yₜ, qₜ, uₜ)=CONTROLLER(xₜ, qₜ₋₁, rₜ, θ)

mₜ=MEM_WRITE(mₜ₋₁, uₜ)

The functions MEM_READ and MEM_WRITE are fixed functions that do not have any trainable parameters. This function is required to be well-defined for all memory sizes, while the memory width is fixed. The function CONTROLLER is determined by the parameters of the neural network, denoted by θ. The number of parameters depends on the domain size and memory width but is required to be independent of the memory size. These conditions ensure that the MANN is memory-size independent.

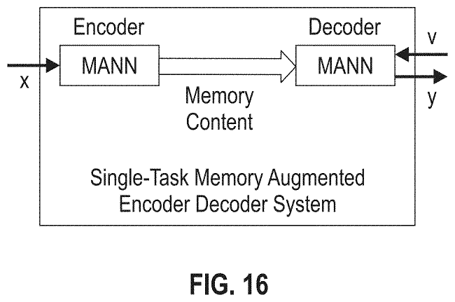

Referring to FIG. 16, a general architecture of a single-task memory-augmented encoder-decoder according to embodiments of the present disclosure is illustrated. A task Tis defined by a pair of input sequences (x, v), where x is the main input and v is the auxiliary input. The goal of the task is to compute a function, denoted also by using notation as T(x, v), in a sequential manner where x is first accessed sequentially followed by accessing v sequentially.

The main input is fed to the encoder. The memory is then transferred at the end of processing x by the encoder, to provide the initial configuration of the memory for the decoder. The decoder takes the auxiliary input v and produces the output y. The Encoder-Decoder is said to solve the task T if y=T(x,v). Some small error may be allowed in this process with respect to some distribution on the inputs.

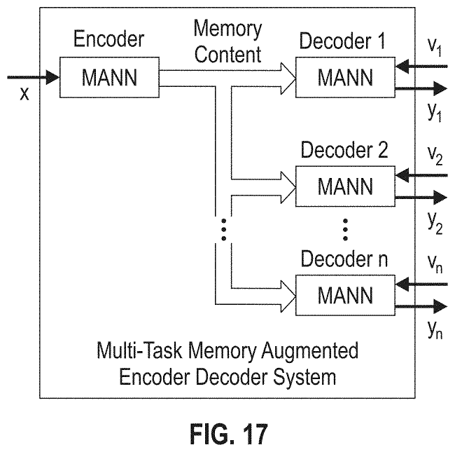

Referring to FIG. 17, a general architecture of a multi-task memory-augmented encoder-decoder according to embodiments of the present disclosure is illustrated. Given a set of tasks [symbol] ={T₁, T₂, . . . , Tₙ} a multi-task memory-augmented encoder-decoder is provided for the tasks in [symbol] , which learns the neural network parameters embedded in the controllers. In various embodiments, a multi-task learning paradigm is applied. In an example, paralleling the tasks discussed above, working memory tasks T={RECALL, REVERSE, ODD, N-BACK, EQUALITY}. Here the domain consists of fixed-width binary strings, e.g., 8-bit inputs.

For every task in T∈ [symbol] , a suitable Encoder-Decoder is determined for T such that all the encoder MANNs for the tasks have an identical structure. In some embodiments, the encoder-decoder is selected based on the characteristics of the tasks in [symbol] .

For the working memory tasks, a suitable choice of encoder is the Neural Turing Machine (NTM) with consecutive attentional mechanism for memory access and content-addressing turned off.

For RECALL, a suitable choice of the decoder could be the same as the encoder.

For ODD, a suitable choice is an NTM that is allowed to shift its attention by 2 steps over memory locations.

A multi-task encoder-decoder system may then be built to train the tasks in [symbol] . Such a system is illustrated in FIG. 17. This system accepts a single main input common to all the tasks and separate auxiliary inputs for the individual tasks. The common memory content after processing the common main input is transferred to the individual decoders.

The multi-task encoder-decoder system may be trained using multi-task training with or without transfer learning, as set forth below.

In multi-task training, a set of tasks [symbol] ={T₁, T₂, . . . , Tₙ} is provided a common domain D. For every task T∈ [symbol] , a suitable encoder-decoder is determined for T such that all the encoder MANNs for the tasks have an identical structure. A multi-task encoder-decoder is built as described above based on the encoder-decoders for the individual tasks. A suitable loss function is determined for each task in [symbol] . For example, the binary cross-entropy function may be used for tasks in [symbol] with binary inputs. A suitable optimizer is determined to train the multi-task encoder-decoder. Training data for the tasks in [symbol] are obtained. The training examples should be such that each sample consists of a common main input to all the tasks and individual auxiliary inputs and outputs for each of the tasks.

An appropriate memory size is determined for handling the sequences in the training data. In the worst case, the memory size is linear in the maximum length of the main or auxiliary input sequences in the training data. The multi-task encoder-decoder is trained using the optimizer until the training loss is reached to an acceptable value.

In joint multi-task training and transfer learning, a suitable subset [symbol] ⊆ [symbol] is determined to be used just for the training of an encoder using a multi-task training process. This can be done by using the knowledge of the characteristics of the class [symbol] . The set {RECALL, REVERSE} may be used for [symbol] with respect to the working memory tasks. The multi-task encoder-decoder is built as defined by the tasks in [symbol] . The same method as outlined above is used to train this multi-task encoder-decoder. Once the training has converged, the parameters of the encoder are frozen as obtained at convergence. For each task T∈ [symbol] , a single-task encoder-decoder is built that is associated with T. The weights are instantiated and frozen (set as non-trainable) for each encoder in all the encoder-decoders. Each of the encoder-decoders are now trained separately to obtain the parameters of the individual decoders.

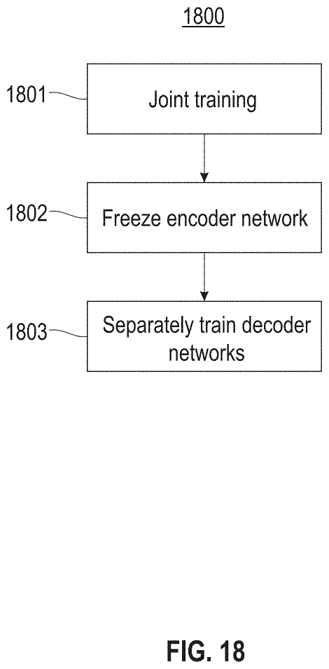

Referring to FIG. 18, a method of operating artificial neural networks is illustrated according to embodiments of the present disclosure. At 1801, a subset of a plurality of decoder artificial neural networks is jointly trained in combination with an encoder artificial neural network. The encoder artificial neural network is adapted to receive an input and provide an encoded output based on the input to a memory. Each of the plurality of decoder artificial neural networks is adapted to receive an encoded input from a memory and provide an output based on the encoded input. At 1802, the encoder artificial neural network is frozen. At 1803, each of the plurality of decoder artificial neural networks is separately trained in combination with the frozen encoder artificial neural network.

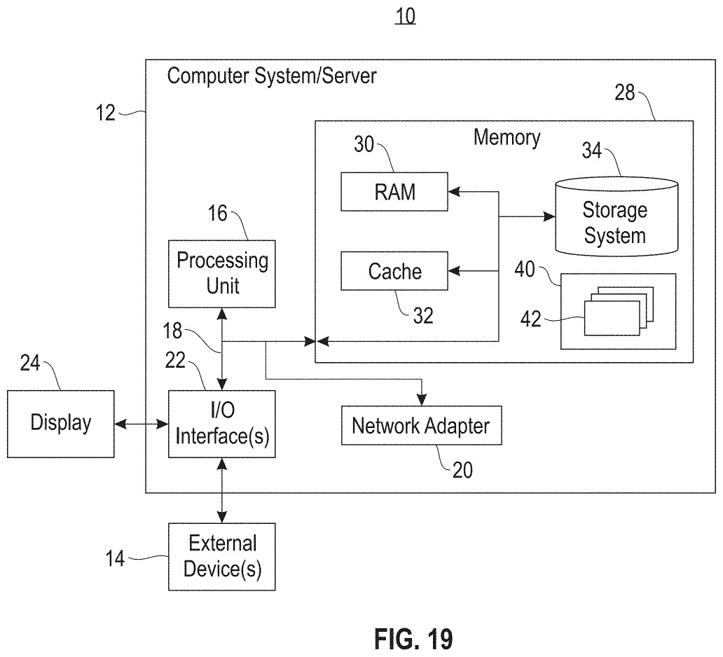

Referring now to FIG. 19, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 19, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
an encoder artificial neural network adapted to receive an input and provide an encoded output based on the input;
a plurality of decoder artificial neural networks, each adapted to receive an encoded input and provide an output based on the encoded input; and
a memory operatively coupled to the encoder artificial neural network and to the plurality of decoder artificial neural networks, the memory adapted to store the encoded output of the encoder artificial neural network, and provide the encoded input to the plurality of decoder artificial neural networks.

2. The system of claim 1, wherein each of the plurality of decoder artificial neural networks corresponds to one of a plurality of tasks.

3. The system of claim 1, wherein the encoder artificial neural network is pretrained on one or more tasks.

4. The system of claim 3, wherein the pretraining comprises:
jointly training each of the plurality of decoder artificial neural networks in combination with the encoder artificial neural network.

5. The system of claim 3, wherein the pretraining comprises:
jointly training a subset of the plurality of decoder artificial neural networks in combination with the encoder artificial neural network;
freezing the encoder artificial neural network;
separately training each of the plurality of decoder artificial neural networks in combination with the frozen encoder artificial neural network.

6. The system of claim 1, wherein the memory comprises an array of cells.

7. The system of claim 1, wherein the encoder artificial neural network is adapted to receive a sequence of inputs, and wherein each of the plurality of decoder artificial neural networks is adapted to provide an output corresponding to each input of the sequence of inputs.

8. The system of claim 1, wherein the each of the plurality of decoder artificial neural networks is adapted to receive an auxiliary input, and wherein the output is further based on the auxiliary input.

9. A method comprising:
jointly training each of a plurality of decoder artificial neural networks in combination with an encoder artificial neural network, wherein
the encoder artificial neural network is adapted to receive an input and provide an encoded output based on the input to a memory, and
each of the plurality of decoder artificial neural networks is adapted to receive an encoded input from a memory and provide an output based on the encoded input.

10. The method of claim 9, wherein each of the plurality of decoder artificial neural networks corresponds to one of a plurality of tasks.

11. The method of claim 9, wherein the encoder artificial neural network is pretrained on one or more tasks.

12. The method of claim 11, wherein the pretraining comprises:
jointly training each of the plurality of decoder artificial neural networks in combination with the encoder artificial neural network.

13. The method of claim 11, wherein the pretraining comprises:
jointly training a subset of the plurality of decoder artificial neural networks in combination with the encoder artificial neural network;
freezing the encoder artificial neural network;
separately training each of the plurality of decoder artificial neural networks in combination with the frozen encoder artificial neural network.

14. The method of claim 9, wherein the memory comprises an array of cells.

15. The method of claim 9, further comprising:
receiving by the encoder artificial neural network a sequence of inputs; and
providing by each of the plurality of decoder artificial neural networks an output corresponding to each input of the sequence of inputs.

16. The method of claim 9, further comprising:
receiving by each of the plurality of decoder artificial neural networks an auxiliary input, wherein the output is further based on the auxiliary input.

17. A method comprising:
jointly training a subset of a plurality of decoder artificial neural networks in combination with an encoder artificial neural network, wherein
the encoder artificial neural network is adapted to receive an input and provide an encoded output based on the input to a memory, and
each of the plurality of decoder artificial neural networks is adapted to receive an encoded input from a memory and provide an output based on the encoded input;
freezing the encoder artificial neural network; and
separately training each of the plurality of decoder artificial neural networks in combination with the frozen encoder artificial neural network.

18. The method of claim 17, wherein each of the plurality of decoder artificial neural networks corresponds to one of a plurality of tasks.

19. The method of claim 17, further comprising:
receiving by the encoder artificial neural network a sequence of inputs; and
providing by each of the plurality of decoder artificial neural networks an output corresponding to each input of the sequence of inputs.

20. The method of claim 17, further comprising:
receiving by each of the plurality of decoder artificial neural networks an auxiliary input, wherein the output is further based on the auxiliary input.
